(19) United States
(12) Patent Application Publication
(10) Pub. No.: US 2006/0149433 A1
(43) Pub. Date: Jul. 6, 2006

(54) Failure diagnosing device and method for vehicular control apparatus

(76) Inventors: Hideaki Otsubo, Nishikamo-gun (JP); Toshinari Suzuki, Nishikamo-gun (JP); Tooru Matsubara, Toyota-shi (JP); Tadasu Tomohiro, Toyota-chi (JP); Masato Kaigawa, Toyota-shi (JP); Yoshiharu Harada, Toyota-shi (JP); Masashi Ono, Ama-gun (JP)

Correspondence Address: KENYON & KENYON LLP, 1500 K STREET N.W., SUITE 700, WASHINGTON, DC, 20005, US

(21) Appl. No.: 10/544,994

(22) PCT Filed: Apr. 21, 2004
(86) PCT No.: PCT/IB04/01200

§ 371 Date: Aug. 9, 2005

(30) Foreign Application Priority Data
Apr. 22, 2003 (JP) 2003-117391

(51) Int. Cl. G01M 17/00; G06F 19/00

(52) U.S. Cl. 701/29; 701/31; 701/35

(57) ABSTRACT

A failure determination threshold value H_{SH} used for making a failure determination for a control apparatus, for example, a lock-up clutch (26) by failure determining means (116) is corrected by failure determination threshold value correcting means (114) based on a continuation quantity q_{NG}, for example, a duration t_{NG}, of an operation state in which a predetermined failure precondition for the control apparatus mounted on a vehicle is satisfied. Therefore, a failure determination is performed by the failure determining means (116) using the failure determination threshold value H_{SH} obtained in consideration of individual differences such as variations between vehicles. As a result, it is possible to prevent an erroneous determination regarding a failure, and to improve sensitivity of a failure determination.

### BACKGROUND OF THE INVENTION

1. Field of Invention

The invention relates to a failure diagnosing device and method for a vehicular control apparatus, which determines that a failure has occurred in a control apparatus mounted on a vehicle, when a continuation quantity of an operation state of the control apparatus, in which a predetermined failure precondition is satisfied, exceeds a predetermined failure determination threshold value. More particularly, the invention relates to a technology for preventing the failure diagnosing device and method from making an erroneous determination regarding a failure, and for improving sensitivity of a failure determination, by correcting the failure determination threshold value based on the continuation quantity of the operation state in which the predetermined failure precondition is satisfied.

2. Description of Related Art

There is a known vehicle provided with a failure diagnosing device which determines whether a failure has occurred in a control apparatus mounted on the vehicle. For example, the failure diagnosing device determines that a failure has occurred in the control apparatus when a predetermined failure precondition, which is satisfied only when a failure occurs, is satisfied. However, in an actual operation of the control apparatus, the failure precondition is satisfied even when the control apparatus is operating normally, depending on contents of the failure precondition. Therefore, there is a possibility to erroneously determine that a failure has occurred in the control apparatus, even when the control apparatus is operating normally. Accordingly, in order to avoid such an erroneous determination, there is proposed a technology for determining that a failure has occurred when the continuation quantity of the operation state, in which the failure precondition is satisfied, exceeds a predetermined failure determination threshold value, e.g. a predetermined time. For example, as shown in Japanese Patent Laid-Open Publication No. JP-A-11-287319, there is a technology for making a failure determination, in consideration of delay in response due to a time lag between when a shifting command is issued and when shifting is completed, in shift control of an automatic transmission. According to the technology, a determination, that a failure has occurred in the control apparatus, is made when the continuation quantity of the operation state, in which the failure precondition is satisfied, exceeds the predetermined period. Namely, a determination, that a failure has occurred in the control apparatus, is made when the period, in which a gear ratio of a shifting command disagrees with an actual gear ratio, exceeds the predetermined period.

However, in order to prevent an erroneous determination due to a driving operation, a running condition, and individual differences such as variations of vehicles, it is necessary to set the failure determination threshold value and the failure precondition with leeway. Accordingly, there is a possibility that the sensitivity of a failure determination is reduced. Namely, prevention of an erroneous determination regarding a failure and prevention of reduction in the determination sensitivity are incompatible with each other. Therefore, it is difficult to prevent both an erroneous determination regarding a failure and reduction in the determination sensitivity.

### DISCLOSURE OF THE INVENTION

It is an object of the invention to provide a failure diagnosing device and method for a vehicular control apparatus, which determines that a failure has occurred in the control apparatus mounted on a vehicle, when a continuation quantity of an operation state of the control apparatus, in which a predetermined failure precondition is satisfied, exceeds a predetermined failure determination threshold value. More particularly, it is an object of the invention to provide a failure diagnosing device and method for a vehicle, which is prevented from making an erroneous determination regarding a failure and whose sensitivity of the failure determination is improved, by correcting a failure determination threshold value based on a continuation quantity of an operation state in which a predetermined failure precondition is satisfied.

According to a first aspect of the invention, there is provided a failure diagnosing device for a vehicular control apparatus, which includes (a) failure determining means for determining that a failure has occurred in the control apparatus when a continuation quantity of an operation state of the control apparatus, in which a predetermined failure precondition is satisfied, exceeds a predetermined failure determination threshold value, characterized by including (b) failure determination threshold value correcting means for correcting the failure determination threshold value based on an actual continuation quantity of the operation state.

Thus, the failure determination threshold value, which is used for determining whether a failure has occurred in the control apparatus by the failure determining means, is corrected by the failure determination threshold value correcting means based on the continuation quantity of the operation state of the control apparatus, in which the predetermined failure precondition is satisfied. Accordingly, it is possible to make a failure determination by the failure determining means using the failure determination threshold value which is set in consideration of the individual differences such as variations of vehicles. As a result, it is possible to prevent an erroneous determination regarding a failure, and to improve the sensitivity of the failure determination.

In this case, correction by the failure determination threshold value correcting means is preferably performed based on the continuation quantity of the operation state where the control apparatus is operating normally and the continuation quantity is smaller than the failure determination threshold value. Thus, the failure determination threshold value is appropriately corrected by the failure determination threshold value correcting means. As a result, an erroneous determination regarding a failure by the failure determining means is prevented, and the sensitivity of the failure determination is improved.

It is also preferable that the failure diagnosing device include (a) storing means for storing the actual continuation quantity, and (b) the failure determination threshold value correcting means correct the failure determination threshold value based on a storage value stored in the storing means. Thus, correction of the failure determination threshold value by the failure determination threshold value correcting means is appropriately performed based on the actual continuation quantity.

It is also preferable that the failure diagnosing device include (a) continuation quantity detecting means for detecting an actual continuation quantity of the operation state of the control apparatus each time when the predetermined failure precondition is satisfied, and (b) smoothing means for smoothing fluctuation in the continuation quantity of the operation state which is repeatedly detected by the continuation quantity detecting means, and (c) the storing means store a smooth processed value obtained by the smoothing means. Thus, it is possible to appropriately correct the failure determination threshold value using the failure determination threshold value correcting means, based on the smooth processed value which is obtained, using the smoothing means, by smoothing the fluctuation in the actual continuation quantity of the operation state, the fluctuation being due to causes other than individual differences such as variations of vehicles, for example, the fluctuation being due to causes such as the driving operation and the running condition.

It is also preferable that the continuation quantity be the duration of the operation state in which the predetermined failure precondition is satisfied, and the storing means store the number of times that the actual continuation quantity or the smooth processed value exceeds the predetermined time. Thus, the number of times that actual continuation quantity or the smooth processed value exceeds the predetermined time is stored in the storing means. As a result, it is possible to reduce the amount of information to be stored in the storing means, thereby preventing garbling of the storage value and/or deterioration of durability of the storing means.

It is also preferable that the continuation quantity be the duration of the operation state in which the predetermined failure precondition is satisfied, and the storing means store the actual continuation quantity or the smooth processed value which exceeds the predetermined time. Thus, since only the actual continuation quantity or the smooth processed value which exceeds the predetermined time is stored in the storing means. As a result, it is possible to reduce the amount of information to be stored in the storing means, thereby preventing garbling of the storage value and/or deterioration of durability of the storing means.

It is also preferable that the storing means store the maximal value of the actual continuation quantity or the maximal value of the smooth processed value. Thus, since only the maximal value of the actual continuation quantity or the maximal value of the smooth processed value is stored in the storing means. As a result, it is possible to reduce the amount of information to be stored in the storing means, thereby preventing garbling of the storage value and/or deterioration of durability of the storing means.

It is also preferable that the failure determination threshold value correcting means do not correct the failure determination threshold value when a failure determination for the control apparatus is not performed by the failure determining means. Thus, the failure determination threshold value is corrected by the failure determination threshold value correcting means only when a failure determination for the control apparatus is performed. As a result, it is possible to appropriately determine whether a failure has occurred in the control apparatus.

It is also preferable that the storing means do not store the actual continuation quantity or the smooth processed value when a failure determination for the control apparatus is not performed by the failure determining means. Thus, the actual continuation quantity or the smoothing value stored in the storing means does not include the actual continuation quantity or the smooth processed value when a failure determination for the control apparatus is not performed. As a result, it is possible to appropriately correct the failure determination threshold value using the failure determination threshold value correcting means, and to appropriately determine whether a failure has occurred in the control apparatus.

It is also preferable that the control apparatus be a power transmission system which transmits power of an engine to drive wheels. For example, it is appropriately determined whether a failure has occurred in a solenoid valve which controls shifting of an automatic transmission as the power transmission system and hydraulic pressure of a lock-up clutch provided in a torque converter.

According to a second aspect of the invention, there is provided a failure diagnosing method for a vehicular control apparatus, which includes (a) failure determining step for determining that a failure has occurred in the control apparatus when a continuation quantity of an operation state of the control apparatus, in which a predetermined failure precondition is satisfied, exceeds a predetermined failure determination threshold value, characterized by comprising the step of: (b) correcting the failure determination threshold value based on an actual continuation quantity of the operation state.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view schematically showing a power transmission system to which the invention is applied;

FIG. 2 is a table showing engaged/disengaged states of clutches and applied/released states of brakes for achieving each shift speed of an automatic transmission in FIG. 1;

FIG. 3 is a diagram showing input/output signals to be input in/output from an electronic control unit provided in a vehicle according to an embodiment in FIG. 1;

FIG. 4 is a perspective view concretely showing a shift lever in FIG. 3;

FIG. 5 is a graph showing an example of a relationship between an accelerator pedal operation amount A_{CC} and a throttle valve opening amount θ_{TH}, used in throttle control performed by the electronic control unit in FIG. 3;

FIG. 6 is a graph showing an example of a shift diagram (map) used in shift control of the automatic transmission, which is performed by the electronic control unit in FIG. 3;

FIG. 7 is a graph showing a lock-up range diagram used in control of a lock-up clutch in the power transmission system in FIG. 1;

FIG. 8 is a view showing an example of a lock-up control apparatus as a hydraulic circuit portion related to the control of the lock-up clutch of a hydraulic pressure control circuit in FIG. 3;

FIG. 9 is a graph showing output characteristics of a linear solenoid valve SLU in FIG. 8;

FIG. 10 is a functional block diagram showing a main portion of a control function of the electronic control unit in FIG. 3;

FIG. 11A is a graph showing an example of measurement values of the duration when the lock-up clutch is engaged in a normal state, and an example of a failure determination threshold value. FIG. 11B is a graph showing an example of measurement values of the duration depending on the individual difference between vehicles, and an example of setting the failure determination threshold value;

FIG. 12 is a flowchart describing the main portion of the control function of the electronic control unit in FIG. 3, that is, a control operation for correcting the failure determination threshold value used in the failure determination operation for the control apparatus provided in the vehicle; and

FIG. 13 is a flowchart describing the main portion of the control function of the electronic control unit in FIG. 3, that is, the failure determination operation for the control apparatus provided in the vehicle.

### DETAILED DESCRIPTION OF THE PREFERRED EMBODIMENTS

Hereafter, an embodiment of the invention will be described in detail with reference to accompanying drawings.

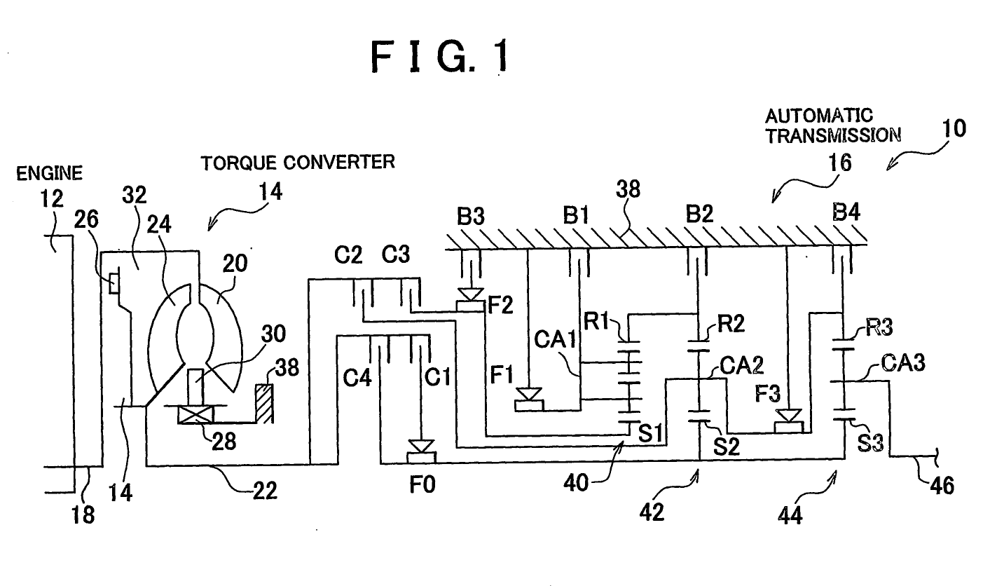

FIG. 1 is a view schematically showing a power transmission system 10 to which the invention is applied. In FIG. 1, output from an engine 12, which is used as a driving force source for running and which is constituted of an internal combustion engine, is transmitted to an automatic transmission 16 via a torque converter 14 used as a fluid type power transmission system, and is then transmitted to drive wheels via a differential gear unit and an axle (not shown). The torque converter 14 includes a pump impeller 20 which is coupled to the engine 12, a turbine runner 24 which is coupled to an input shaft 22 of the automatic transmission 16, and a stator impeller 30 which is allowed to rotate in only one direction and which is inhibited from rotating in the other direction by a one-way clutch 28. In the torque converter 14, power is transmitted between the pump impeller 20 and the turbine runner 24 via fluid. The torque converter 14 also includes a lock-up clutch 26 for directly connecting the pump impeller 20 and the turbine runner 24. The lockup clutch 26 is a hydraulic friction clutch which is frictionally engaged according to a pressure difference ΔP between hydraulic pressure in an engagement side oil chamber 32 and hydraulic pressure in a disengagement side oil chamber 34. When the lock-up clutch 26 is fully engaged, the pump impeller 20 and the turbine runner 24 integrally rotate. Also, by controlling the pressure difference ΔP, that is, the engagement torque, in a feedback manner such that the lock-up clutch 26 is engaged in a predetermined slip state, the turbine runner 24 is rotated in accordance with the rotation of the pump impeller 20 in a predetermined slip amount, e.g. 50 rpm, when the vehicle is driven (when power is ON). Meanwhile, when the vehicle is not driven (power is OFF), the pump impeller 20 is rotated in accordance with the rotation of the turbine runner 24 in a predetermined slip amount, e.g. −50 rpm.

The automatic transmission 16 is a planetary gear type transmission which includes a first planetary gear drive 40, that is the double pinion type, and a second planetary gear drive 42, and a third planetary gear drive 44, that are the single pinion type. A sun gear S1 of the first planetary gear drive 40 is selectively coupled to the input shaft 22 via a clutch C3, and is selectively coupled to a housing 38 via a one way clutch F2 and a brake B3, whereby rotation in the reverse direction (the direction opposite to direction in which the input shaft 22 rotates) is inhibited. A carrier CA1 of the first planetary gear drive 40 is selectively coupled to the housing 38 via a brake B1, and rotation in the reverse direction is inhibited at all times by a one way clutch F1 provided in parallel with the brake B1. A ring gear R1 of the first planetary gear drive 40 is integrally coupled to a ring gear R2 of the second planetary gear drive 42, and is selectively coupled to the housing 38 via a brake B2. A sun gear S2 of the second planetary gear drive 42 is integrally coupled to a sun gear S3 of the third planetary gear drive 44. The sun gear S2 of the second planetary gear drive 42 is selectively coupled to the input shaft 22 via a clutch C4, and is selectively coupled to the input shaft 22 via a one way clutch F0 and a clutch C1, whereby the sun gear S2 is inhibited from relatively rotating in the reverse direction with respect to the input shaft 22. A carrier CA2 of the second planetary gear drive 42 is integrally coupled to a ring gear R3 of the third planetary gear drive 44. The carrier CA2 of the second planetary gear drive 42 is selectively coupled to the input shaft 22 via a clutch C2, and is selectively coupled to the housing 38 via a brake B4, whereby the carrier CA2 is inhibited from rotating in the reverse direction at all times by a one way clutch F3 provided in parallel with the brake B4. A carrier CA3 of the third planetary gear drive 44 is integrally coupled to an output shaft 46.

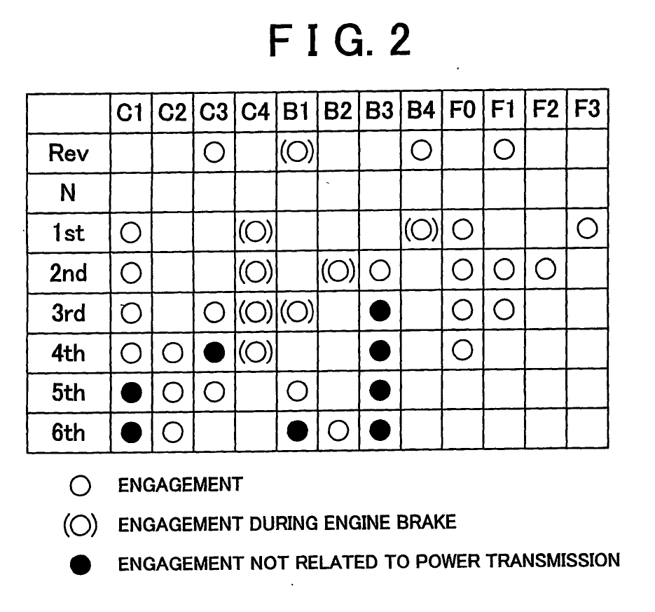

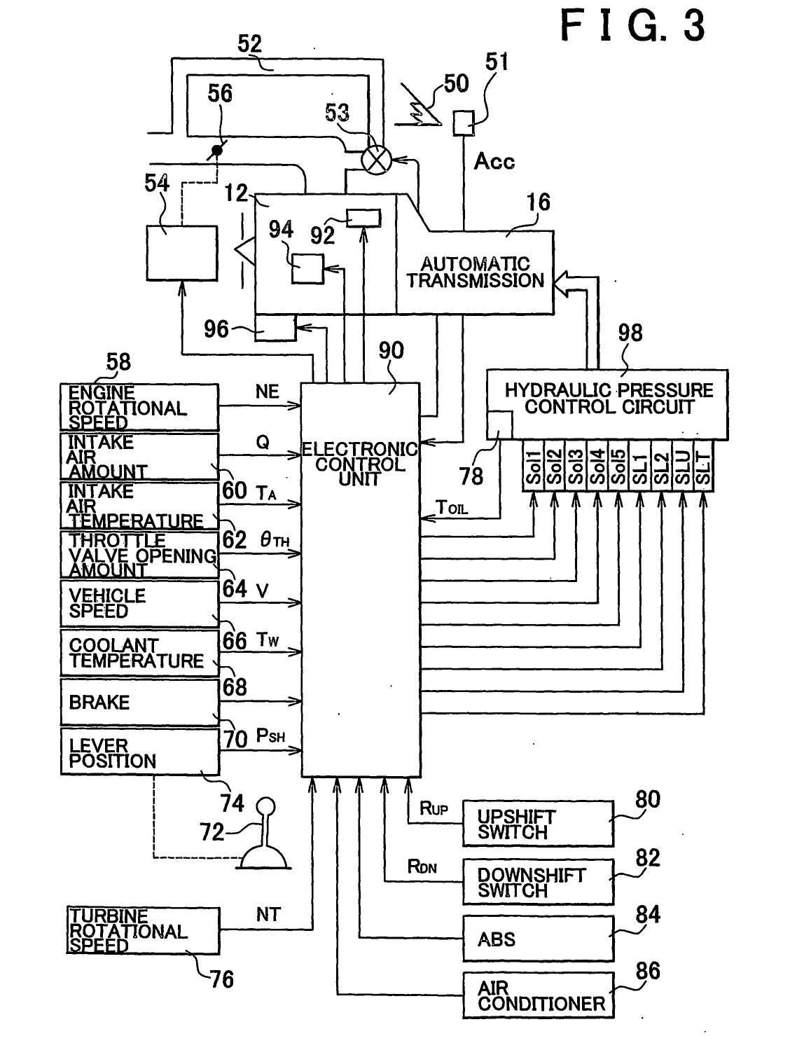

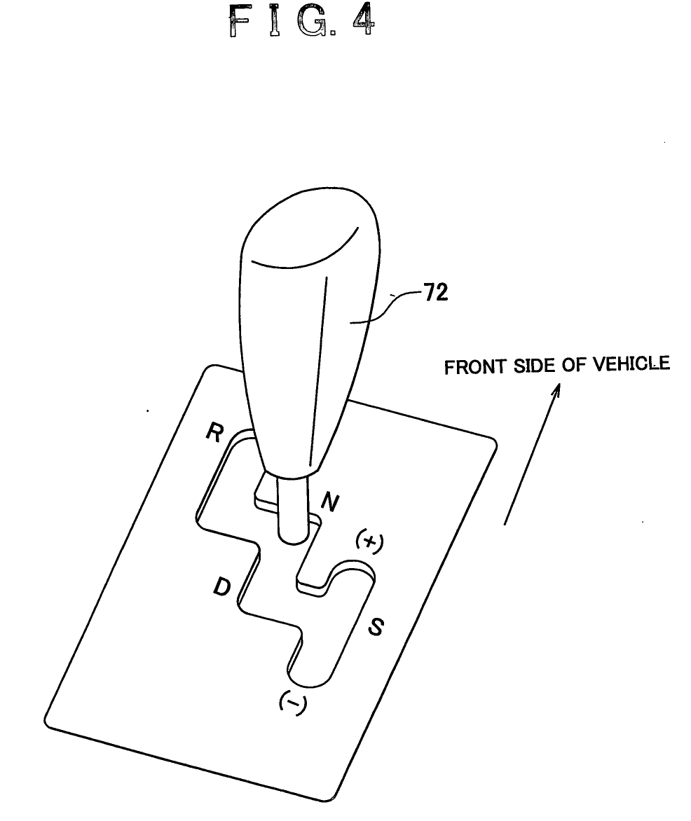

The clutches C1 to C4 and the brakes B1 to B4 (hereinafter, simply referred to as “clutches C2” and “brakes B”, respectively, when not specified further) are hydraulic friction engaging devices, the clutches C being, for example, multi-disc clutches and the brakes B being, for example, multi-disc brakes which are controlled by hydraulic actuators. These clutches C and brakes B are switched between an engaged/applied state and a disengaged/released state, as shown in FIG. 2, for example, by switching solenoid valves Sol1 to Sol5 and linear solenoid valves SL1 and SL2 of a hydraulic pressure control circuit 98 (refer to FIG. 3) between an energized state and a de-energized state, or by switching a hydraulic circuit using a manual valve (not shown). Each speed, i.e., six forward speeds (1st to 6th), and one reverse speed (Rev) is achieved according to a position of a shift lever 72 (refer to FIG. 4). The denotations “1st” to “6th” in FIG. 2 denote the first forward speed to the sixth forward speed, respectively. A gear ratio γ(=rotational speed of the input shaft 22 N_{IN}/rotational speed of the output shaft 46 N_{OUT}) becomes smaller from the first speed “1st” to the sixth speed “6th”. The gear ratio of the fourth speed “4th” is “1.0”. In FIG. 2, a circle indicates an engaged/applied state of the clutches C, brakes B and one-way clutches F. A blank column indicates a disengaged/released state of the clutches C, brakes B and one-way clutches F. A circle in parentheses indicates an engaged/applied state of the clutches C and the brakes B when an engine brake is applied. A black circle indicates an engaged/applied state of the clutches C, and the brakes B, which is not related to power transmission.

The hydraulic pressure control circuit 98 in FIG. 3 includes a linear solenoid valve SLU which mainly controls the lock-up hydraulic pressure, that is, the pressure difference ΔP between the hydraulic pressure in the engagement side oil chamber 32 and the hydraulic pressure in the disengagement side oil chamber 34, and a linear solenoid valve SLT which mainly controls the line hydraulic pressure, in addition to the solenoid valves Sol1 to Sol5, and the linear solenoid valves SL1 and SL2 for shifting. The operating oil in the hydraulic pressure control circuit 98 is supplied to the lock-up clutch 26, and is also used to lubricate various elements such as the automatic transmission 16.

FIG. 3 is a block diagram showing a control system provided in a vehicle, for controlling the engine 12 and the automatic transmission 16 in FIG. 1. The accelerator pedal operation amount A_{CC}, which is the operation amount of an accelerator pedal 50, is detected by an accelerator pedal operation amount sensor 51. The accelerator pedal 50 is depressed according to the amount of output requested by a driver. The accelerator pedal 50 corresponds to an accelerator operating member, and the accelerator pedal operation amount A_{CC} corresponds to the amount of output requested by the driver. An electronic throttle valve 56 is provided in an intake pipe of the engine 12. The opening amount of the electronic throttle valve 56 is made equal to the opening amount corresponding to the accelerator pedal operation amount A_{CC}, that is, the throttle valve opening amount θ_{TH}, by an throttle actuator 54. Also, in a bypass passage 52 which bypasses the electronic throttle valve 56 for idle speed control, there is provided an ISC (idle speed control) valve 53 that controls the intake air amount when the electronic throttle valve 56 is fully closed, in order to control an idle speed NE_{ELDL} of the engine 12. In addition, other sensors and switches are also provided, such as an engine rotational speed sensor 58 for detecting an engine rotational speed N_{E} of the engine 12; an intake air amount sensor 60 for detecting an intake air amount Q of the engine 12; an intake air temperature sensor 62 for detecting a temperature T_{A} of the intake air; a sensor 64 for a throttle with an idle switch, for detecting whether the electronic throttle valve 56 is fully closed (i.e., whether the engine 12 is in an idle state) as well as for detecting the throttle valve opening amount θ_{TH} of that electronic throttle valve 56; a vehicle speed sensor 66 for detecting a vehicle speed V (corresponding to a rotational speed N_{OUT} of the output shaft 46); a coolant temperature sensor 68 for detecting a coolant temperature T_{W} of the engine 12; a brake switch 70 for detecting whether a foot brake, that is a service brake, is operated; a lever position sensor 74 for detecting a lever position (i.e., an operating position) P_{SH} of the shift lever 72; a turbine rotational speed sensor 76 for detecting a turbine rotational speed N_{T} (=rotational speed N_{IN} of the input shaft 22); an AT oil temperature sensor 78 for detecting an AT oil temperature T_{OIL}, that is the temperature of the operating oil in the hydraulic pressure control circuit 98; an upshift switch 80; and a downshift switch 82. Signals from these sensors and switches indicative of the engine rotational speed N_{E}; intake air amount Q; intake air temperature T_{A}; throttle valve opening amount θ_{TH}; vehicle speed V; engine coolant temperature T_{W}; a brake operation state; a lever position P_{SH} of the shift lever 72; turbine rotation speed N_{T}; AT oil temperature T_{OIL}; a shift range up command R_{UP}; a shift range down command R_{DN}; and the like are supplied to an electronic control unit (hereinafter, simply referred to as an “ECU”) 90. Also, the ECU 90 is connected to an ABS (antilock brake system) 84 for controlling the braking force such that the wheels are not locked (slip) when the foot brake is operated, and is provided with information related to the brake hydraulic pressure corresponding to the braking force. The ECU 90 is also provided with a signal indicative of whether an air conditioner 86 is operated.

The ECU 90 includes a microcomputer that has a CPU, RAM, ROM, an input/output interface and the like. The CPU performs output control of the engine 12, shift control of the automatic transmission 16, lock-up clutch control of the lock-up clutch 26 and the like by processing signals according to a program stored in the ROM in advance while using the temporary storage function of the RAM. When necessary, the CPU may be configured such that a portion thereof for engine control is separated from a portion thereof for shift control.

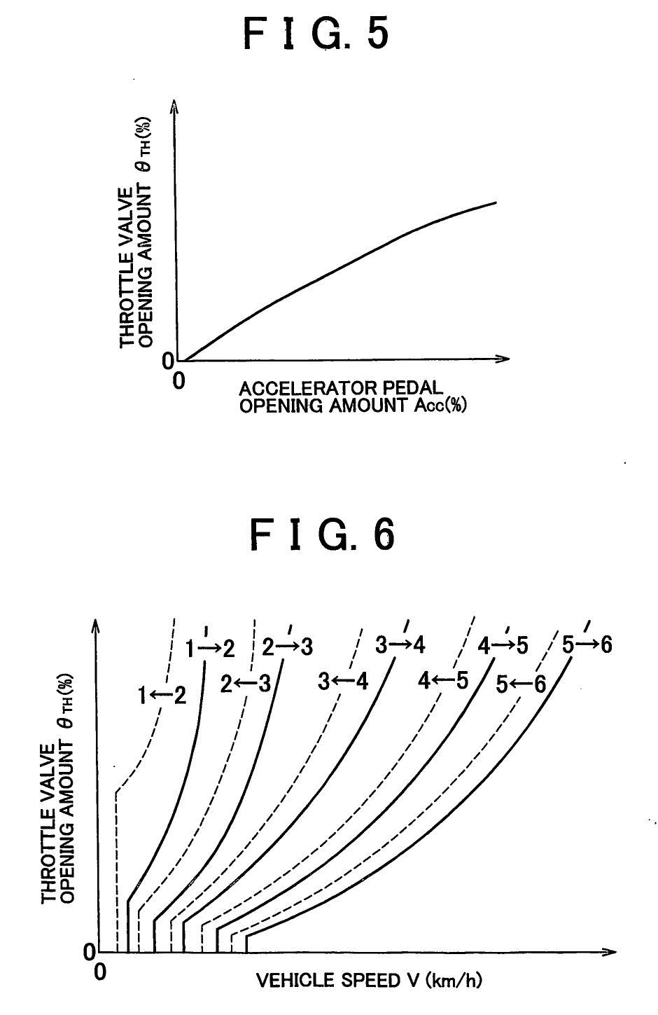

In the output control of the engine 12, opening/closing of the electronic throttle valve 56 is controlled by the actuator 54. Also, a fuel injection device 92 is controlled for controlling the fuel injection amount, an ignition device 94, e.g. an igniter, is controlled for controlling the ignition timing, and the ISC valve 53 is controlled for controlling the idle speed. In the control of the electronic throttle valve 56, for example, the throttle actuator 54 is driven based on the actual accelerator pedal operation amount A_{CC} according to the relationship between the accelerator pedal operation amount A_{CC} and the throttle valve opening amount θ_{TH}, shown in FIG. 5, and the throttle valve opening amount θ_{TH} is increased with an increase in the accelerator pedal operation amount A_{CC}. When the engine 12 is started, a crank shaft 18 of the engine 12 is cranked (started to rotate) by a starter (electric motor) 96.

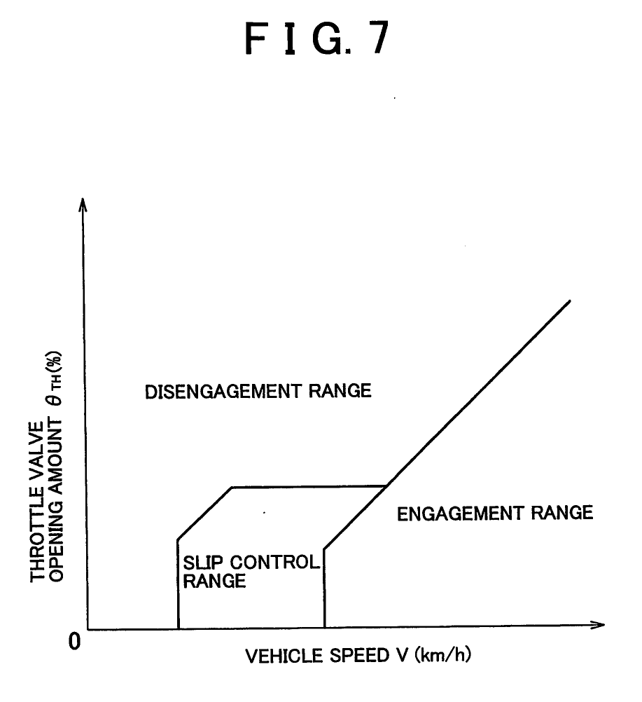

In the shift control of the automatic transmission 14, the shift speed of the automatic transmission 14 to be achieved is decided based on the actual throttle valve opening amount θ_{TH} and the vehicle speed V using, for example, the shift diagram (shift map), which is stored in advance, shown in FIG. 6, depending on the lever position P_{SH} of the shift lever 72 shown in FIG. 4. Then, shifting from the current shift speed to the target shift speed is performed, and shift output for starting shift operation to the target shift speed is performed. The shift lever 72 is provided near a driver's seat, and is manually operated so as to be at one of four lever positions, that are, “R (reverse)”, “N (neutral)”, “D (drive)”, and “S (sequential)”. The “R” position is a reverse running position. The “N” position is a power transmission interrupting position. The “D” position is a forward running position by automatic shifting. The “S” position is a forward running position at which manual shifting can be performed by switching a plurality of shift ranges whose high speed side shift speeds are different from each other. The lever position sensor 74 detects the lever position to which the shift lever 72 is operated. The lever positions “R”, “N”, “D (S)” are formed in the longitudinal direction of the vehicle (the upper side of FIG. 4 corresponds to the front side of the vehicle). By mechanically operating a manual valve, which is coupled to the shift lever 72 via a cable or a link, according to the operation of the shift lever 72 in the longitudinal direction, the hydraulic circuit is changed. When the shift lever 72 is at the “R” position, the reverse shift speed “Rev” shown in FIG. 2 is achieved, for example, by mechanically realizing a reverse circuit. When the shift lever 72 is at the “N” position, a neutral circuit is mechanically realized, and all the clutches C and the brakes B are disengaged/released.

When the shift lever 72 is operated to the “D” position or the “S” position, that are the forward running positions, the forward running circuit is mechanically realized by changing the hydraulic circuit using the manual valve according to the operation of the shift lever 72. Thus, it is possible to run forward while performing shifting among the forward shift speeds, the first shit speed “1st” to the sixth shift speed “6th”. When the shift lever 72 is operated to the “D” position, the operation of the shift lever to the “D” position is determined according to a signal from the lever position sensor 74, and an automatic shift mode is realized, and shift control is performed using all the forward shift speeds from the first shift speed “1st” to the sixth shift speed “6th”. Namely, in order to avoid occurrence of shift shocks such as a change in the drive force and deterioration of a frictional member, by switching the solenoid valves Sol1 to Sol5 and the linear solenoid valves SL1 and SL2 between the energized state and the de-energized state, the hydraulic pressure control circuit 98 is changed and one of the forward shift speeds from the first shift speed “1st” to the sixth shift speed “6th” is achieved. In FIG. 6, a solid line shows upshifting, and a dashed line shows downshifting. As the vehicle speed V decreases, or as the throttle valve opening amount θ_{TH} increases, the present shift speed is switched to a lower shift speed where the gear ratio (=input rotational speed N_{IN}/output rotational speed N_{OUT}) is higher. The numbers “1” to “6” signify the shift speeds from the first shift speed “1st” to the sixth shift speed “6th”, respectively. Each of the first shift speed “1st” to the fourth shift speed “4th” is achieved by engaging the one way clutches F0 to F3. Accordingly, in order to prevent the automatic transmission from being in the neutral state during deceleration of the vehicle, the clutches C or the brakes B (hereafter, referred to as “engine brake elements”) corresponding to the circle in FIG. 2 are engaged so as to obtain an engine brake effect. By obtaining the engine brake effect during deceleration of the vehicle, it is possible to increase the braking force of the vehicle. Meanwhile, it is possible to enhance fuel efficiency by fuel cut, since transmission is brought to the neutral state and therefore the drive wheels and the input shaft 22 separated from each other, and the engine rotational speed N_{E} is prevented from temporarily decreasing in accordance with the turbine rotational speed N_{T}, such that the fuel cut state realized by a fuel cut device is maintained as long as possible.

When the shift lever 72 is operated to the “S” position, the operation of the shift lever 72 to the “S” position is determined according to a signal from the lever position sensor 74, and the manual shift mode is realized. The “S” position is formed at the same position as the “D” position in the longitudinal direction of the vehicle, and is formed adjacent to the “D” position in the width direction of the vehicle. When the shift lever 72 is at the “S” position, the hydraulic circuit is the same as that when the shift lever 72 is at the “D” position. However, the manual shift mode is electrically realized. In the manual shift mode, it is possible to arbitrarily select a plurality of shift ranges decided among the shift speeds which can be achieved at the “D” position, that is, among the first shift speed “1st” to the sixth shift speed “6th”. In the “S” position, an upshift position “+” and a downshift position “−” are formed in the longitudinal direction of the vehicle. When the shift lever 72 is operated to the upshift position “+” or the downshift position “−”, the operation of the shift lever 72 to the upshift position “+” or the downshift position “−” is detected by the upshift switch 80 or the downshift switch 82. Then, one of the six shift ranges “D”, “5”, “4”, “3”, “2” and “L” whose highest shift speeds, that are, the high speed side shift ranges, where the gear ratios are small, are different from each other, is electrically realized according to the upshift command R_{UP} or the downshift command R_{DN}. Also, shift control is automatically performed according to, for example, the shift map shown in FIG. 6 in each shifting range. The shift lever 72 is not held at the upshift position “+” or the downshift position “−” firmly, and the shift lever 72 is automatically returned to the “S” position by urging means such as a spring. The shift range is changed according to the number of times that the shift lever 72 is operated to the upshift position “+” or the downshift position “−”, or according to the period in which the shift lever 72 is held at the upshift position “+” or the downshift position “−”.

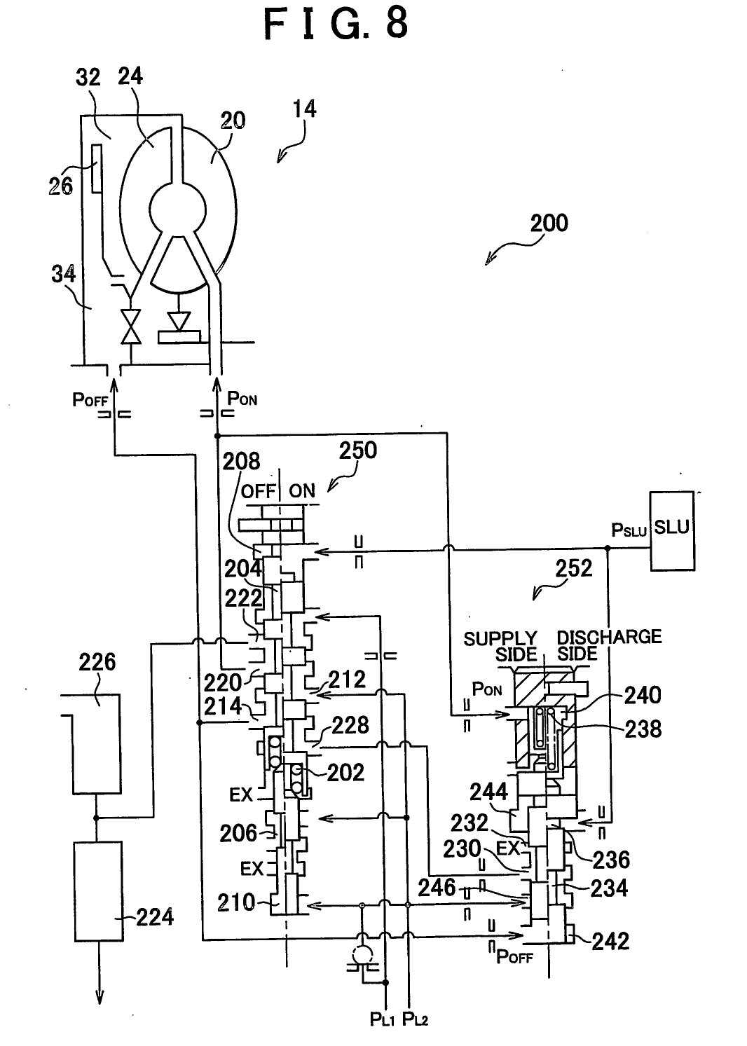

In the lock-up clutch control of the lock-up clutch 26, the engagement torque, that is, the engagement force of the lock-up clutch 26 can be continuously controlled. The ECU 90 functionally includes lock-up clutch control means 100 for controlling the engaged state of the lock-up clutch 26 according to the map having the disengagement range, the slip control range, and the engagement range, which is stored in advance using the throttle valve opening amount θ_{TH} and the vehicle speed V as parameters, as shown in FIG 7. In order to make the rotational speed difference (slip amount) N_{SLP} between the turbine rotational speed N_{T} and the engine rotational speed N_{E} (=N_{E}−N_{T}) equal to the target rotational speed difference (target slip amount) N_{SLP}*, the ECU 90 outputs a drive duty ratio D_{SLU} which is a drive signal for the solenoid valve SLU for controlling the pressure difference ΔP of the lock-up clutch 26. In the slip control, the lock-up clutch 26 is maintained in the slip state in order to suppress a loss in power transmission of the torque converter 14 as effectively as possible while absorbing fluctuation in the rotational speed of the engine 10, thereby enhancing the fuel efficiency as effectively as possible without deteriorating drivability. In the slip control, the deceleration running time slip control is performed, for example, in the shift speed where the reverse input from the drive wheel side, that is caused during forward running when the throttle valve opening amount θ_{TH}, is substantially “0” and the vehicle is idle running (deceleration running), is transmitted to the engine 12 side, that is, the shift speed where the engine brake effect can be obtained. The turbine rotational speed N_{T} and the engine rotational speed N_{E} are moderately decreased in accordance with deceleration of the vehicle in the state where the rotational speed difference N_{SLP} is made substantially equal to the target rotational speed difference N_{SLP}*, e.g. −50 rpm through the feedback control using the drive duty ratio D_{SLU} for the solenoid valve SLU. As mentioned above, when the lock-up clutch 26 is slip-engaged, the engine rotational speed N_{E} is increased to a value substantially equal to the turbine rotational speed N_{T}. Therefore, the fuel cut range (vehicle speed range), where the fuel supply to the engine 12 is stopped, is extended, and therefore the fuel efficiency is enhanced.

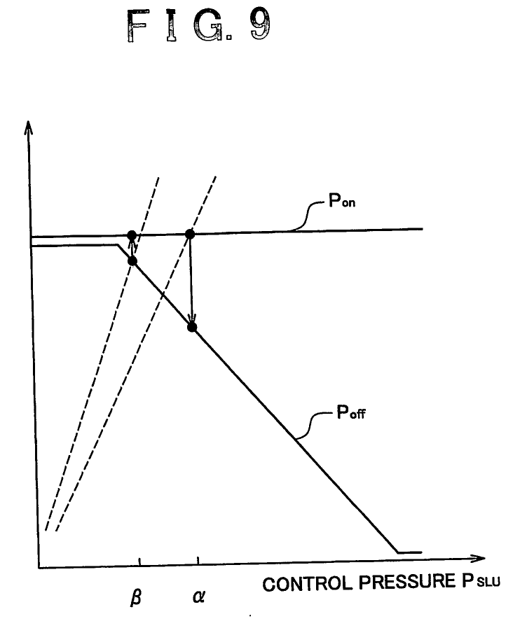

FIG. 8 is a view showing an example of a lock-up control device 200 as a hydraulic circuit portion related to the control of the lock-up clutch 26 of the hydraulic pressure control circuit 98. The linear solenoid valve SLU, which serves as a control pressure generating valve, is a pressure reducing valve using modulator pressure P_{M} as original pressure. The linear solenoid valve SLU outputs the control pressure P_{SLU} which increases according to the drive current I_{SLU} based on the drive duty ratio D_{SLU} that is output from the ECU 90, and supplies the control pressure P_{SLU} to a lock-up relay valve 250 and a lock-up control valve 252.

The lock-up relay valve 250 includes a first spool valve element 204 and a second spool valve element 206 which can contact each other and between which a spring 202 is provided; an oil chamber 208 which is provided on the shaft end side of the first spool valve element 204, and which is supplied with the control pressure P_{SLU} for urging the first spool valve element 204 and the second spool valve element 206 to the engagement (ON) side position; and an oil chamber 210 which is supplied with the second line pressure P_{L2} for urging the first spool valve element 204 and the second spool valve element 206 to the disengagement (OFF) side position. When the first spool valve element 204 is at the disengagement side position, the second line pressure P_{L2} supplied to an input port 212 is supplied from a disengagement side port 214 to the disengagement side oil chamber 34 of the torque converter 14, and the operating oil in the engagement side oil chamber 32 of the torque converter 14 is discharged to a cooler bypass valve 224 or an oil cooler 226 through an engagement side port 220 and a discharge port 222. Thus, the engagement pressure of the lock-up clutch 26, that is the pressure difference ΔP (=hydraulic pressure in the engagement side oil chamber 32−hydraulic pressure in the disengagement side oil chamber 34) is decreased. On the other hand, when the first spool valve element 204 is at the engagement side position, the second line pressure P_{L2} supplied to the input port 212 is supplied from the engagement side port 220 to the engagement side oil chamber 32 of the torque converter 14, and the operating oil in the disengagement side oil chamber 34 of the torque converter 14 is discharged through the disengagement side port 214, a discharge port 228, a control port 230 of the lock-up control valve 252, and a discharge port 232, whereby the engagement pressure of the lock-up clutch 26 is increased.

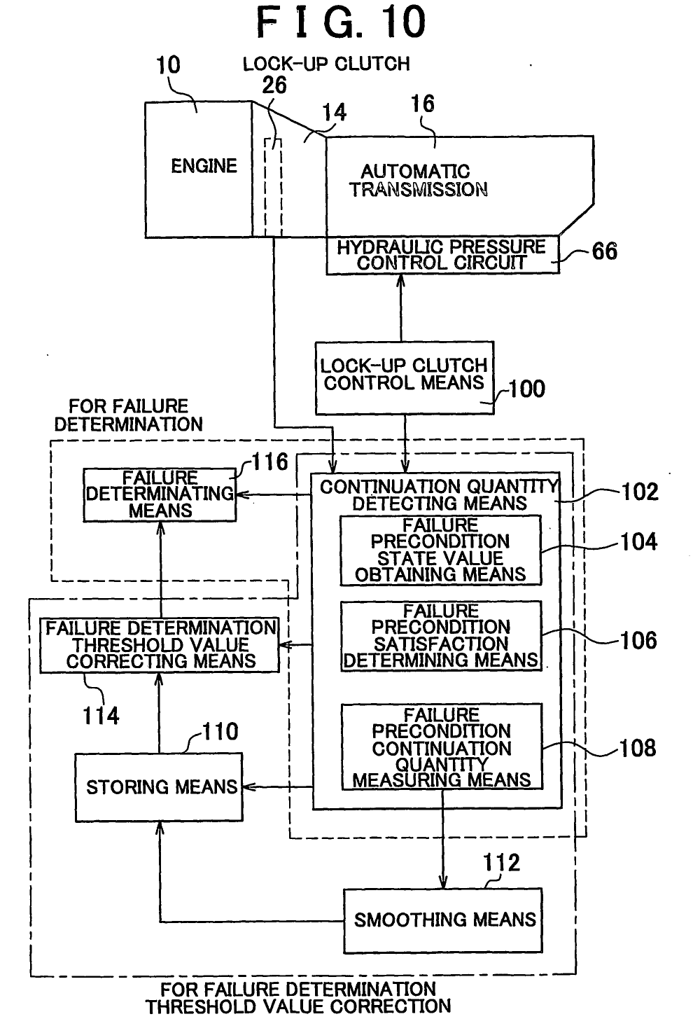

Therefore, when the control pressure P_{SLU} is equal to or lower than a predetermined value β (refer to FIG. 9), the first spool valve element 204 is brought to the engagement side (OFF) position, which is on the left side with respect to a center line of the lock-up relay valve 250 shown in FIG. 8, according to the pressing force due to the spring 202 and the second line pressure P_{L2}, and the lock-up clutch 26 is disengaged. Meanwhile, when the control pressure P_{SLU} exceeds a predetermined value α, which is higher than the predetermined value β, the first spool valve element 204 is brought to the engagement (ON) side position, which is on the right side with respect to the center line of the lock-up relay valve 250 shown in FIG. 8, according to the pressing force due to the control pressure P_{SLU}, and the lock-up clutch 26 is engaged or brought to the slip state. The pressure receiving areas of the first spool valve element 204 and the second spool valve element 206, and the urging force of the spring 202 are thus set. The engagement or the slip state of the lock-up clutch 26 when the lock-up relay valve 250 is switched to the engagement side is controlled by the lock-up control valve 252 which is operated according to the control pressure P_{SLU}.

The lock-up control valve 252 controls the slip amount N_{SLP} of the lock-up clutch 26 according to the control pressure P_{SLU} and engages the lock-up clutch 26 when the lock-up relay valve 250 is at the engagement side position. The lock-up control valve 252 includes a spool valve element 234; a plunger 236 which contacts the spool valve element 234, and supplies pressing force to the spool valve element 234 for moving to the discharge side position, which is on the left side with respect to the center line of the lock-up control valve 252 shown in FIG. 8; a spring 238 which supplies pressing force to the spool valve element 234 for moving to the supply side position, which is on the right side with respect to the center line of the lock-up control valve 252 shown in FIG. 8; an oil chamber 240 which houses the spring 238 and which is supplied with the hydraulic pressure P_{ON} in the engagement side oil chamber 32 of the torque converter 14 so as to urge the spool valve element 234 toward the supply side position; an oil chamber 242 which is provided on the shaft end side of the plunger 236 and which is supplied with the hydraulic pressure P_{OFF} in the disengagement side oil chamber 34 of the torque converter 14 so as to urge the spool valve element 234 toward the discharge side position; and an oil chamber 244 which is provided in a middle portion of the plunger 236 and which is supplied with the control pressure P_{SLU}.

Therefore, when the spool valve element 234 is brought to the discharge side position, communication is provided between the control port 230 and the discharge port 232. Accordingly, the engagement pressure is increased, and the engagement torque of the lock-up clutch 26 is increased. On the other hand, when the spool valve element 234 is brought to the supply side position, communication is provided between the supply port 246, to which the first line pressure P_{L1} is supplied, and the control port 230. Accordingly, the first line pressure P_{L1} is supplied to the disengagement side oil chamber 34 of the torque converter 14, the engagement pressure is decreased, and the engagement torque of the lock-up clutch 26 is decreased.

When the lock-up clutch 26 is disengaged, the linear solenoid valve SLU is driven by the ECU 90 such that the control pressure P_{SLU} becomes a value smaller than the predetermined value β. On the other hand, when the lock-up clutch 26 is engaged, the linear solenoid valve SLU is driven by the ECU 90 such that the control pressure P_{SLU} becomes the maximal value. When the lock-up clutch 26 is brought to the slip state, the linear solenoid valve SLU is driven by the ECU 90 such tat the control pressure P_{SLU} becomes a value between the predetermined value β and the maximal value. In the lock-up control valve 252, the hydraulic pressure P_{ON} in the engagement side oil chamber 32 and the hydraulic pressure P_{OFF} in the disengagement side oil chamber 34 of the torque converter 14 are changed according to the control pressure P_{SLU}. Accordingly, the engagement torque of the lock-up clutch 26, corresponding to the engagement pressure, that is, the pressure difference ΔP between the hydraulic pressure P_{ON} and the hydraulic pressure P_{OFF} (P_{ON}−P_{OFF}) is changed according to the control pressure P_{SLU}, whereby the slip amount N_{SLP} is controlled.

In FIG. 9, the upper dashed line shows the hydraulic pressure characteristics of the lock-up relay valve 250, which are required for switching the lock-up relay valve 250 from the ON side position, where the lock-up clutch 26 is engaged or in the slip state, to the OFF side position, where the lock-up clutch 26 is disengaged. The lower dashed line shows the hydraulic pressure characteristics of the lock-up relay valve 250, which are required for switching the lock-up relay valve 250 from the OFF side position to the ON side position. The inclinations of the dashed lines are decided based on the areas of the pressure receiving portions of the first spool valve element 204 and the second spool valve element 206 for operating the lock-up relay valve 250, the hydraulic pressure to be supplied, and the characteristics of the spring 202.

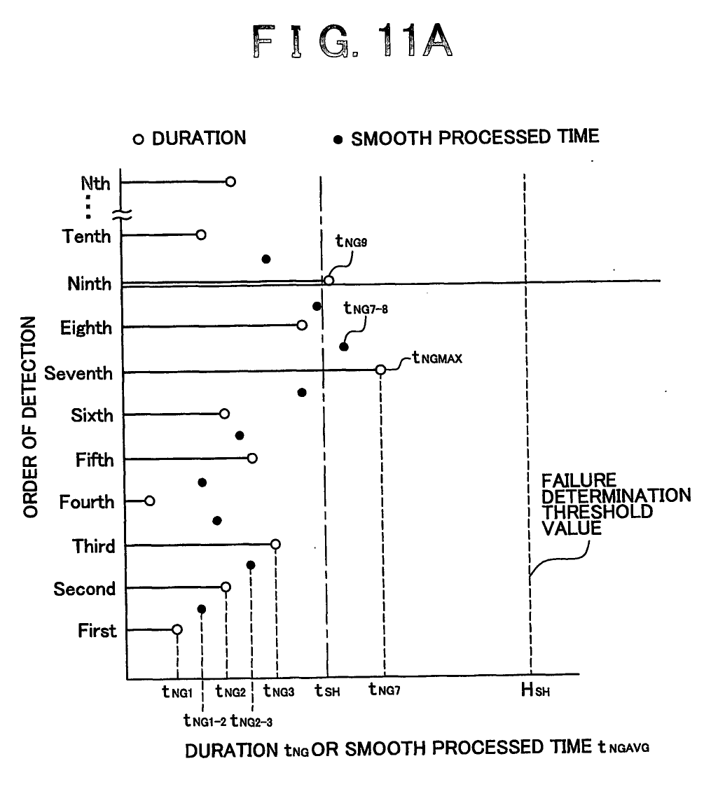

FIG. 10 is a functional block diagram showing a main portion of the control function of a failure diagnosing device which makes a failure determination for a control apparatus provided in the ECU 90. In FIG. 10, the lock-up clutch control means 100 outputs the drive duty ratio D_{SLU}, which is a drive signal for the solenoid valve SLU for controlling the pressure difference ΔP of the lock-up clutch 26, to the hydraulic pressure control circuit 66, in order to control the engaged state of the lock-up clutch 26 according to the prestored map having the disengagement range, the slip control range, and the engagement range, that are prestored in the two-dimensional coordinate. The two-dimensional coordinate uses the throttle valve opening amount θ_{TH} and the vehicle speed V as parameters, as shown in FIG. 7.

Continuation quantity detecting means 102 includes failure precondition state value obtaining means 104, failure precondition satisfaction determining means 106, and failure precondition continuation quantity measuring means 108. The continuation quantity detecting means 102 determines whether a predetermined failure precondition for the control apparatus is satisfied, and detects the continuation quantity q_{NG} of the operation state of the control apparatus each time when the failure precondition is satisfied.

The failure precondition state value obtaining means 104 obtains a failure precondition state value indicative of the present vehicle state which is required for determining whether the predetermined failure precondition is satisfied. The predetermined failure precondition is used for making a failure determination for the vehicular control apparatus, and is the failure precondition which is used for determining the occurrence of a failure when the failure occurs in the control apparatus. For example, in the case where control is performed by the lock-up clutch control means such that the power transmission system as the vehicular control apparatus, e.g. the lock-up clutch 26 is fully engaged, a failure occurs when the rotational speed difference (slip amount) N_{SLP} between the turbine rotational speed N_{T} and the engine rotational speed N_{E} (=N_{E}−N_{T}) occurs, that is the rotational speed difference N_{SLP} is not substantially “0” while the drive duty ratio D_{SLU}, that is the drive signal for the solenoid valve SLU, is output such that the predetermined pressure difference ΔP_{ON} required for lock-up on is obtained and therefore the pump impeller 20 and the turbine runner 24 are integrally rotated. The failure precondition during lock-up on control of the lock-up clutch 26 is a plurality of the failure preconditions, that is, a failure precondition group. Examples of the failure preconditions are as follows; the shift speed is the predetermined shift speed; the control pressure P_{SLU} is higher than the predetermined hydraulic pressure, that is, the pressure difference ΔP is higher than the predetermined pressure difference ΔP_{ON} required for lock-up on; the throttle valve opening amount θ_{TH} is in the predetermined range; the vehicle speed V is in the predetermined range; and the absolute amount of the rotational speed difference N_{SLP} is larger than predetermined rotational speed difference N_{SLP-P}. The failure precondition state value obtaining means 104 obtains or detects the failure precondition state values required for determining whether the failure precondition group is satisfied. Example of the failure precondition state values are the present shift speed, the control pressure P_{SLU}, the throttle valve opening amount θ_{TH}, the vehicle speed V, and the rotational speed difference N_{SLP}.

The failure precondition satisfaction determining means 106 determines whether the present operation state is in the operation state where the predetermined failure precondition (the failure precondition group, when there is a plurality of the failure preconditions) for the control apparatus is satisfied. For example, when control is performed such that the lock-up clutch 26 is engaged, the failure precondition satisfaction determining means 106 determines whether the plurality of the failure preconditions, that is, the failure precondition group, is satisfied based on the failure precondition state values of the vehicle detected by the failure precondition state value obtaining means 104, such as the present shift speed, the control pressure P_{SLU}, the throttle valve opening amount θ_{TH}, the vehicle speed V, the rotational speed difference N_{SLP}. Example of the failure preconditions are as follows; the shift speed is the predetermined shift speed; the control pressure P_{SLU} is higher than the predetermined hydraulic pressure; the throttle valve opening amount θ_{TH} is in the predetermined range; the vehicle speed V is in the predetermined range; and the absolute amount of the rotational speed difference N_{SLP} is larger than predetermined rotational speed difference N_{SLP-P}.

The failure precondition continuation quantity measuring means 108 measures the actual continuation quantity q_{NG} of the operation state in which the failure precondition is continuously satisfied, when it is determined that the failure precondition is satisfied by the failure precondition satisfaction determining means 106. When it is determined that the failure precondition is not satisfied by the failure precondition satisfaction determining means 106, the continuation quantity q_{NG} is regarded as “0”. For example, the actual continuation quantity q_{NG} is the duration t_{NG} of the operation state in which the predetermined failure precondition (the failure precondition group, when there is a plurality of the failure preconditions) is satisfied, or the number of times k_{NG} that the operation state, in which the predetermined failure precondition (failure precondition group, there is a plurality of the failure preconditions) is satisfied, is realized.

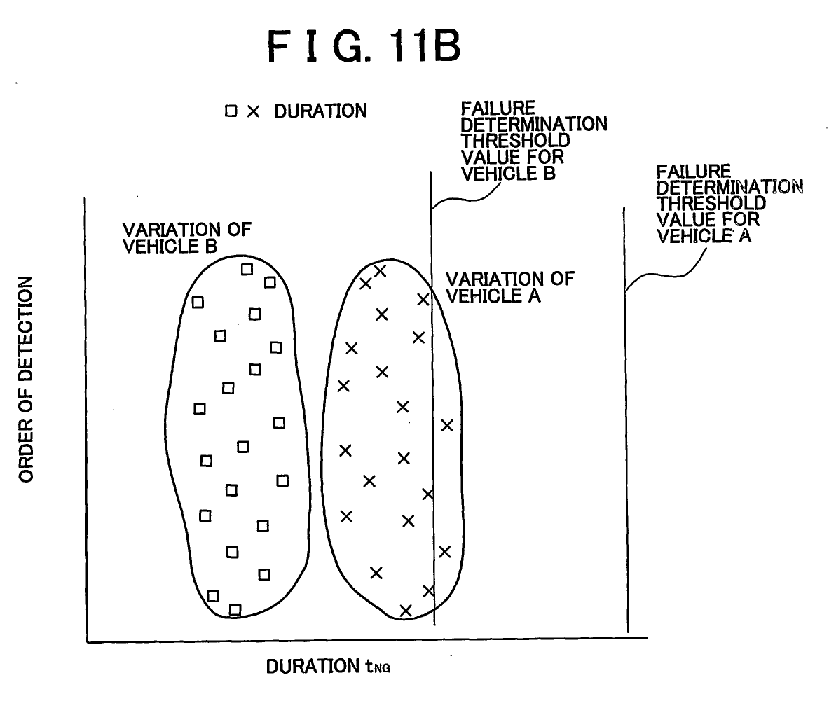

The failure determining means 116 determines whether the continuation quantity q_{NG} measured by the failure precondition continuation quantity measuring means 108 exceeds the prestored failure determination threshold value H_{SH}, and sets a failure determination flag according to the result of the determination. For example, the failure determining means 116 sets the failure determination flag to 1″ when it is determined that the continuation quantity q_{NG} exceeds the failure determination threshold value H_{SH}, and sets the failure determination flag to “0”, until the time when the continuation quantity q_{NG} exceeds the failure determination threshold value H_{SH}. The failure precondition is satisfied not only when a failure has occurred in the control apparatus but also when the control apparatus is operating normally, depending on the contents of the failure precondition. For example, even when the drive duty ration D_{SLU} is output such that the lock-up clutch 26 is engaged, the control apparatus is in the slip state, that is, in the operation state where the failure precondition is satisfied until the time when the lock-up clutch 26 is actually engaged, due to delay in response of the hydraulic pressure, or the like. If it is determined that a failure has occurred in the control apparatus simply because the failure precondition is satisfied, there is a possibility that an erroneous determination is made. Therefore, in order to avoid such an erroneous determination, the failure determination threshold value H_{SH} is set such that a failure determination is not made based on the continuation quantity q_{NG} of the failure precondition which is satisfied in the normal state, and further, such that it is promptly determined that a failure has occurred when a failure has actually occurred. FIG. 11A and FIG. 11B show examples of the continuation quantity q_{NG} when the lock-up clutch 26 is engaged in the normal state, for example, the measurement value of the duration t_{NG} (circle point), and examples of setting the failure determination threshold value H_{SH}. The measurement values of the duration t_{NG}, (circle points) vary, as shown in FIG. 11A. As shown in FIG. 11B. the measurement values vary depending on the individual differences between a vehicle A and a vehicle B, or depending on a driver. Accordingly, in order to avoid an erroneous determination made by the failure determining means 116, the failure determination threshold value H_{SH} is set with leeway, in consideration of the variation range of the continuation quantity q_{NG} in the normal state due to the individual differences between the vehicles in the case of the mass production vehicles, the driving operation, the running condition or the like.

However, when the variation range is considerably large, the failure determination threshold value H_{SH} is increased. Therefore, even when the duration t_{NG} fluctuates largely due to a failure, there is a possibility that it is not determined a failure has occurred. For example, when the failure determination threshold value H_{SH} is set to the value shown by the solid line A, in consideration of the entire variation ranges of the vehicle A and the vehicle B, even if the duration t_{NG} largely fluctuates in the vehicle B due to a failure, there is a possibility that it is not determined a failure has occurred. On the other hand, when the failure determination threshold value H_{SH} is decreased in order to improve the sensitivity of the failure determination, even if the duration t_{NG} fluctuates in the normal state, there is a possibility that it is erroneously determined that a failure has occurred. For example, when the failure determination threshold value H_{SH} is set to the value shown by the solid line B based on the variation range for the vehicle B, even if the duration t_{NG} fluctuates in the vehicle A in the normal state, there is a possibility that it is erroneously determined that a failure has occurred. Therefore, a problem may occur that prevention of an erroneous determination regarding a failure and improvement in the sensitivity of the failure determination are incompatible with each other. Also, the failure determining means 116 need not make a determination when a failure determination cannot be made appropriately. For example, the failure determining means 116 need not make a determination, when there is an effect of another failure occurrence, e.g. when the ECU 90 determines that the turbine rotational speed N_{E} is “0” due to a failure in the turbine rotational speed sensor 76 caused by braking of wire or the like and the slip amount N_{SLP} (N_{E}−N_{T}) becomes considerably large. Also, the failure determining means 116 need not make a determination when the operating oil temperature of the lock-up clutch 26 largely deviates from the normal temperature, e.g., when the operating oil temperature is considerably low, e.g. near 0° C., or considerably high, e.g. near 140° C., and the operating characteristics of the lock-up clutch 26 are different from those in the normal state, for example. when the operating oil temperature is considerably low and delay in response occurs more frequently.

Therefore, in order to achieve both prevention of an erroneous determination regarding the failure and improvement in the sensitivity of the failure determination, the continuation quantity q_{NG} of the failure precondition, which is satisfied even in the normal state, is stored, the failure determination threshold value H_{SH} for each vehicle is decided based on the storage value, and a failure determination is made by the failure determining means 116. For example, in the vehicle A shown in FIG. 11B, the failure determination threshold value H_{SH} for the vehicle A is set to the value shown by the solid line A, and the failure determination is made based on the failure determination threshold value H_{SH} for the vehicle A. In the vehicle B shown in FIG. 11B, the failure determination threshold value H_{SH} for the vehicle B is set to the value shown by the solid lines B, and the failure determination is made based on the failure determination threshold value H_{SH} for the vehicle B. Hereafter, the method for setting the failure determination threshold value H_{SH}, and the method for correcting the preset failure determination threshold value H_{SH} will be described in detail.

The smoothing means 112 is used as means for obtaining the variation range of the continuation quantity q_{NG}. The smoothing means 112 smoothes the actual continuation quantity q_{NG} of the operation state of the control apparatus, which is repeatedly measured by the failure precondition continuation quantity measuring means 108 each time when the predetermined failure precondition state is satisfied, and obtains the smooth processed value q_{NGAVG}. The fluctuation in the continuation quantity q_{NG} is smoothed in order to obtain the medium value of variation of the actual continuation quantity q_{NG}. For example, as shown in FIG. 11A, in order to reduce the difference between the duration t_{NG2}, which is the actual continuation quantity q_{NG} when the lock-up clutch 26 is engaged, e.g. one of the measurement values (circle points) of the duration t_{NG}, and the duration t_{NG1}, which is a value obtained immediately before obtaining the duration t_{NG2}, the smooth processed value, i.e., an average value t_{NG1-2} between the duration t_{NG1} and the duration t_{NG2}, is calculated. Similarly, in order to reduce the difference between the duration t_{NG2} and the duration t_{NG3}, which is a value obtained immediately after obtaining the duration t_{NG2}, the smooth processed value, i.e., an average value t_{NG2-3} between the duration t_{NG2} and the duration t_{NG3}, is calculated. Each black circle in FIG. 11A shows the smooth processed time t_{NGAVG} which is the smooth processed value q_{NGAVG} that is obtained by smoothing the duration t_{NG}. The smoothing means 112 is used for reducing the fluctuation in the duration t_{NG}, the fluctuation being due to causes other than individual differences between the vehicles, the fluctuation being due to causes such as the driving operation and the running condition.

The storing means 110 stores the actual continuation quantity q_{NG} which is measured by the failure precondition continuation quantity measuring means 108 each time when the operation state; in which the failure precondition is satisfied while the control apparatus is operating normally, is realized, or the smooth processed value q_{NGAVG} obtained by smoothing the continuation quantity q_{NG} by the smoothing means 112, as a storage value M. Namely, the storing means 110 stores the variation range of the continuation quantity q_{NG} when the control apparatus is operating normally. Therefore, by storing the storage value M, it is possible to set the failure determination threshold value H_{SH} for each vehicle in consideration of the individual differences such as variation between the vehicles. Therefore, it is not determined that a failure has occurred even when the operation state, in which the failure precondition is satisfied, is realized while the control apparatus is operating normally, and also it is promptly determined that a failure has occurred when a failure has actually occurred. As a result, it is possible to prevent the failure determining means 116 from making an erroneous determination regarding a failure in the control apparatus, thereby improving accuracy in detecting a failure.

The storage value M stored in the storing means 110 is used as a reference for setting the failure determination threshold value H_{SH}, as mentioned above. If the variation range of the actual continuation quantity q_{NG} can be obtained, it is possible to set the failure determination threshold value H_{SH} for preventing an erroneous determination regarding a failure. In this case, the variation range of the actual continuation quantity q_{NG} is the variation range when the operation state, in which the failure precondition is satisfied, is realized. Accordingly, the storing means 110 may select the value which shows the variation range of the actual continuation quantity q_{NG} from the actual continuation quantity q_{NG} which is repeatedly measured or the smooth processed value q_{NGAVG} of the actual continuation quantity q_{NG}, and may set the selected value as the storage value M. Hereafter, examples of the methods for storing the storage value M will be described based on the duration t_{NG} or the smooth processed time T_{NGAVG} in FIG. 11A.

For example, in order to obtain the upper limit of the variation range, the selection time t_{SH}, which is set to a value approximately half of the failure determination threshold value H_{SH}, may be set as a predetermined time, and only the duration t_{NG} or the smooth processed time t_{NGAVG} which exceeds the selection time t_{SH} may be stored as the storage values M. For example, only the duration t_{NG7} and t_{NG9}, or only the smooth processed time t_{NF7-8} may be stored as the storage values M, in the case in FIG. 11A. In order to obtain the tendency of the variation, the number of times N_{SH} that the duration t_{NG} or the smooth processed time t_{NGAVG} exceeds the selection time t_{SH} may be stored as the storage value M. For example, “2” may be stored as the storage value M in the case of FIG. 11A where the duration t_{NG} shown by a circle is used. Thus, it is possible to obtain the tendency of the variation, for example, the duration tends to be longer than the selection time t_{SH}. Further, in order to obtain the upper limit of the variation range, the largest value of the duration t_{NG} or the smooth processed time t_{NGAVG} may be progressively updated, and only the maximal value may be stored as the storage value M. For example, in the case of FIG. 11 where the duration t_{NG} shown by a circle is used, the duration t_{NG7} may be stored as the maximal duration t_{NGMAX}. Thus, it is possible to reduce the number of the storage values M (the amount of information to be stored) when the storage value M is written in the memory. Therefore, it is possible to store the storage value M efficiently, thereby preventing garbling of the storage value M (transformation the storage value M), and/or deterioration of the durability of the memory.

The storing means 110 need not perform storage when a failure determination cannot be made appropriately. For example, the storing means 110 need not perform storage, when there is an effect of another failure occurrence, e.g. when the slip amount N_{SLP} (=N_{E}−N_{T}) becomes considerably large due to a failure in the turbine rotational speed sensor 76 caused by braking of wire, or the like. Also, the storing means 110 need not perform storage when the operation of the control apparatus is unstable, e.g., when the operating oil temperature is considerably low and delay in response occurs more frequently. Also, since the storage value M is not required when the failure determination is not performed, the above-mentioned storage need not be performed. Thus, it is possible to reduce the amount of unnecessary writing to the memory, thereby reducing the number of the storage values M. However, the condition in which the failure precondition tends to be satisfied may be obtained by the storage value M_{N} when the failure determination is not performed by the failure determining means 116. Therefore, the storage value M when the failure determination is performed by the failure determining means 116, and the storage value M_{N} when the failure determination is not performed by the failure determining means 116 may be distinguished and then stored.

The failure determination threshold value correcting means 114 sets or corrects the failure determination threshold value H_{SH} based on the actual continuation quantity q_{NG} when the operation state, in which the failure precondition is satisfied while the control apparatus is operating normally, is realized; the smooth processed value q_{NGAVG} of the actual continuation quantity q_{NG}; or the storage value M. For example, the new failure determination threshold value H_{SH} is set by increasing the value of the storage value M, e.g. the average value of the storage values M, at a predetermined rate or adding a predetermined value to the storage value M, or the failure determination threshold value H_{SH} is changed at a predetermined increase/decrease rate or using the increase/decrease value corresponding to the storage value M, whereby the failure determination threshold value H_{SH} is corrected by learning. Thus, the failure determination threshold value H_{SH} is set or corrected to a value based on the characteristics of each vehicle by the failure determination threshold value correcting means 114. Therefore, it is possible to prevent the failure determining means 166 from making an erroneous determination regarding a failure when the failure precondition is satisfied while the control apparatus is operating normally. It is also possible to improve the sensitivity of the failure determination.

The failure determination threshold value correcting means 114 need not perform the correction when the failure determination is not performed by the failure determining means 116. Also, when the failure determination is not performed by the failure determining means 116, the failure determination threshold value correcting means 114 need not perform the correction, since the failure determination threshold value H_{SH} is not required. Also, the failure determination threshold value correcting means 114 need not perform the correction based on the storage value M_{N} stored in the storing means 110 when the failure determination is not performed. Thus, it is possible to set the accurate failure determination threshold value H_{SH}.

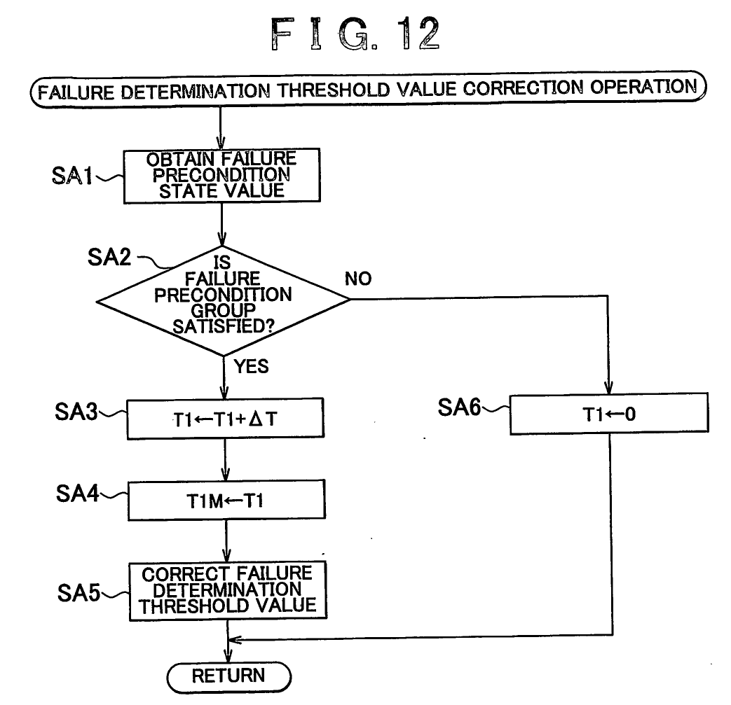

FIG. 12 is a flowchart describing the main portion of the control operation of the ECU 90, that is, the control operation for correcting the failure determination threshold value used for a failure determination operation for the control apparatus provided in the vehicle. In FIG. 12, in step SA1 (hereinafter, simply referred to as “SA1”, the same can be applied to the other steps) corresponding to the failure precondition state value obtaining means 104, the failure precondition state value indicative of the present vehicle state is obtained. The failure precondition state value is necessary for determining whether the predetermined failure precondition is satisfied, which is used for determining whether a failure has occurred in the control apparatus of the vehicle. For example, an abnormal state when the lock-up clutch 26 is engaged is the state where there is the rotational speed difference N_{SLP} between the turbine rotational speed N_{T} and the engine rotational speed N_{E} (=N_{E}−N_{T}) while the drive duty ratio D_{SLU} for lock-up on control is output. The vehicle state values such as the present shift speed, the control pressure P_{SLU}, the throttle valve opening amount θ_{TH}, the vehicle speed V, and the rotational speed difference N_{SLP} are detected. These values are necessary for determining whether a plurality of the failure preconditions, that is, the failure precondition group is satisfied. Examples of the failure preconditions are as follows; the shift speed is the predetermined shift speed; the control pressure P_{SLU} is higher than the predetermined hydraulic pressure, that is, the pressure difference ΔP is higher than the predetermined pressure difference ΔP_{ON} which is required for lock-up on; the throttle valve opening amount θ_{TH} is in the predetermined range; the vehicle speed V is in the predetermined range; and the absolute amount of the rotational speed difference N_{SLP} is larger than the predetermined rotational speed difference N_{SLP-P}. In SA2 corresponding to the failure precondition satisfaction determining means 106, it is determined whether the present operation state is the operation state in which the failure precondition is satisfied. For example, when control is performed such that the lock-up clutch 26 is engaged, it is determined whether the present operation state is the operation state in which the failure precondition group is satisfied, based on the values such as the present shift speed, the control pressure P_{SLU}, the throttle valve opening amount θ_{TH}, the vehicle speed V, and the rotational speed difference N_{SLP}.

When a negative determination is made in SA2, in SA6 corresponding to the failure precondition continuation quantity measuring means 108, the actual continuation quantity q_{NG}, which is the measurement value in the operation state in which the failure precondition is continuously satisfied, is made “0”, afterwhich the routine ends. An example of the actual continuation quantity q_{NG} is the continuation quantity q_{NG} when the lock-up clutch 26 is engaged, e.g. the duration t_{NG}. On the other hand, when an affirmative determination is made in SA2, in SA3 corresponding to the failure precondition continuation quantity measuring means 108, the actual continuation quantity q_{NG}, which is the measurement value in the operation state in which the failure precondition, is continuously satisfied is measured. An example of the actual continuation quantity q_{NG} is the continuation quantity q_{NG} when the lock-up clutch 26 is engaged, e.g. the duration t_{NG}. In SA4 corresponding to the storing means 110, the duration t_{NG} of the operation state, in which the failure precondition is satisfied when the control apparatus is operating normally, is stored as the storage value M. Also, in SA4, the smooth processed time t_{NGAVG} of the duration tNG, which is obtained through smooth process performed by the smoothing means 112, may be stored as the storage value M. The value, which is selected from the duration t_{NG} or the smooth processed time t_{NGAVG} such that the variation range of the duration t_{NG} can be obtained, may be stored as the storage value M. For example, the number of times N_{SH}, that the duration t_{NG} or the smooth processed time t_{NGAVG} exceeds the selection time t_{SH} which is set to a value approximately half of the failure determination threshold value H_{SH}, may be set as the storage value M. The duration t_{NG} or the smooth processed time t_{NGAVG} which exceeds the selection time t_{SH} may be set as the storage value M. Also, the maximal value obtained by successively updating the largest value of the duration t_{NG} or the smooth processed time t_{NGAVG} may be stored as the storage value M.

In SA5 corresponding to the failure determination threshold value correcting means 114, the failure determination threshold value H_{SH} is corrected based on the storage value M in the operation state in which the failure precondition is satisfied when the control apparatus is operating normally. For example, the new failure determination threshold value H_{SH} is set by increasing the average value of the storage values M at a predetermined rate or by adding a predetermined value to the storage value M, or the failure determination threshold value H_{SH} is changed at a predetermined increase/decrease rate or using the increase/decrease value corresponding to the storage value M, whereby the failure determination threshold value H_{SH} is corrected. As a result, the failure determination threshold value H_{SH} is set or corrected to the failure determination threshold value H_{SH} based on the characteristics of each vehicle according to the storage value M of the duration t_{NG} of the operation state in which the failure precondition group is continuously satisfied when the control apparatus is operating normally is satisfied. Correction of the preset failure determination threshold value H_{SH} may be performed automatically by learning, as mentioned above, or may be performed through operation at a plant, a maintenance shop of a dealer, or the like. For example, the vehicle is made to run on a test course or on a chassis dynamo, at the time of factory shipment, in the plant, the maintenance shop of the dealer or the like. Then, the actual continuation quantity q_{NG} of the operation state, in which the failure precondition is continuously satisfied when the control apparatus is operating normally, is detected by a test tool, a test equipment or the like, and the detected value is stored as the storage value M. Also, the failure determination threshold value H_{SH} may be calculated or corrected based on the storage value M, according to an operation manual or the like. Also, calculation or correction of the failure determination threshold value H_{SH} based on the storage value M may be performed automatically by the check tool, the check equipment or the like.

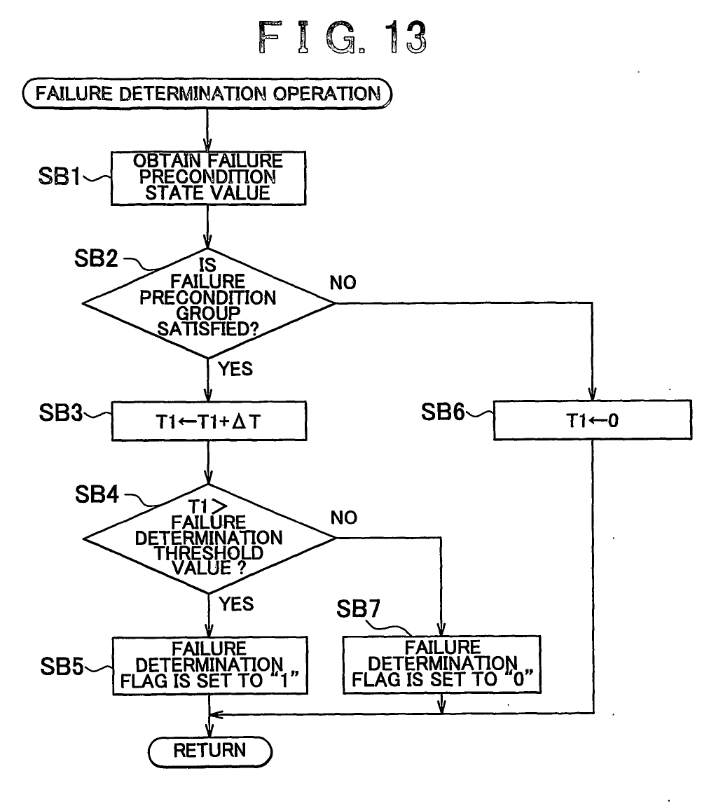

FIG. 13 is a flowchart describing the main portion of the control operation of the electronic control apparatus 90, that is, the failure determination operation for control apparatus provided in the vehicle. SB1 to SB3 and SB6 in the flowchart shown in FIG. 13 are the same as SA1 to SA3 and SA6 in the flowchart shown in FIG. 12, respectively. Therefore, description on SB1 to SB3 and SB6 will be omitted here. In SB4 corresponding to the failure determination means 116, it is determined whether the duration t_{NG} measured in SB3 exceeds the failure determination threshold value H_{SH} which is corrected based on the characteristics of each vehicle, the correction being performed through the control operation for correcting the failure determination threshold value H_{SH} according to the flowchart in FIG 12. When an affirmative determination is made in SB4, in SB5 corresponding to the failure determining means 116, the failure determination flag is set to, for example, “1”. When a negative determination is made in SB4, in SB7 corresponding to the failure determining means 116, the failure determination flag is set to “0” until the time when the duration t_{NG} exceeds the failure determination threshold value H_{SH}. As a result, it is determined whether a failure has occurred in the control apparatus, using the failure determination threshold value H_{SH} which is corrected based on the characteristics of each vehicle. Therefore, it is possible to prevent an erroneous determination regarding a failure when the failure precondition is satisfied while the control apparatus is operating normally. Also, it is possible to improve the sensitivity of the failure determination. The failure determination in SB4 need not be performed, when the failure determination cannot be made appropriately. For example, the failure determination need not be performed, when there is an effect of another failure occurrence, e.g. when the slip amount N_{SLP} (=N_{E}−N_{T}) becomes considerably large due to a failure in the turbine rotational speed sensor 76 caused by braking of wire or the like and. Also, the failure determination need not be performed when the operating oil temperature of the lock-up clutch 26 largely deviates from the normal temperature, e.g., when the operating oil temperature is considerably low, e.g. near 0° C., and delay in response occurs more frequently.

Also, when a failure determination in SB4 in FIG. 13 is not performed, storage in SA4 in FIG. 12 need not be performed, since the operation of the control apparatus is unstable or the storage value M is not required. Thus, it is possible to reduce the amount of unnecessary writing to the memory, thereby reducing the number of the storage values M. However, the condition in which the failure precondition tends to be satisfied may be obtained by the storage value M_{N} when the failure determination is not performed. Therefore, the storage value M when the failure determination is performed, and the storage value M_{N} when the failure determination is not performed may be distinguished and then stored. When the failure determination in SB4 is not performed, correction of the failure determination threshold value H_{SH} in SA5 in FIG. 12 need not be performed, since the operation of the control apparatus is unstable or the storage value M is not required. Also, correction of the failure determination threshold value H_{SH} need not be performed based on the storage value M_{N} when the failure determination is not performed in SB4. Thus, it is possible to set the accurate failure determination threshold value H_{SH}.

As described so far, according to the embodiment, the failure determination threshold value H_{SH}, which is used for determining whether a failure has occurred in the control apparatus, e.g. the lock-up clutch 26 by the failure determining means 116 (SB4), is corrected by the failure determination threshold value correcting means 114 (SA5) based on the continuation quantity q_{NG} of the operation state, in which the predetermined failure precondition for the control apparatus provided in the vehicle is satisfied, for example, the duration t_{NG}. Therefore, a failure determination is performed by the failure determining means 116 using the failure determination threshold value H_{SH} obtained in consideration of individual differences such as the variations between vehicles. As a result, it is possible to prevent an erroneous determination regarding the failure, and to improve the sensitivity of the failure determination.

Also, according to the invention, correction by the failure determination threshold value correcting means 114 (SA5) is performed based on the continuation quantity q_{NG} of the operation state when the control apparatus is operating normally and when the continuation quantity q_{NG} is smaller than the failure determination threshold value H_{SH}. Thus, the failure determination threshold value H_{SH} is appropriately corrected by the failure determination threshold value correcting means 114. As a result, it is possible to prevent the failure determining means 116 from making an erroneous determination regarding a failure (SB4), and to improve the sensitivity of the failure determination.

Also, according to the embodiment, the storing means 110 (SA4) for storing the actual continuation quantity q_{NG} is provided, and the failure determination threshold value correcting means 114 (SA5) corrects the failure determination threshold value H_{SH} based on a storage value M stored in the storing means 110. Thus, correction of the failure determination threshold value H_{SH} is appropriately performed by the failure determination threshold value correcting means 114 based on the actual continuation quantity q_{NG}.

Also, according to the embodiment, the storing means 100 (SA4) stores the smooth processed value q_{NGAVG} of the actual continuation quantity q_{NG} of the operation state of the control apparatus, which is obtained by the smoothing means 112 (SA4), each time when the predetermined failure precondition is satisfied. The continuation quantity q_{NG} is repeatedly detected by the continuation quantity detecting means 102 (SA1 to SA3, SBA to SB3). Therefore, correction of the failure determination threshold value H_{SH} is appropriately performed by the failure determination threshold value correcting means 114 (SA5), based on the smooth processed value q_{NGAVG} which is obtained, using the smoothing means 112, by smoothing the fluctuation in the actual continuation quantity q_{NG} of the operation state, the fluctuation being due to causes other than the individual differences such as the variation of the vehicles, for example, the fluctuation being due to the driving operation or the running condition.

Also, according to the embodiment, the continuation quantity q_{NG} is the duration t_{NG} of the operation state in which the predetermined failure precondition is satisfied, and the storing means 100 (SA4) stores the number of times that the actual continuation quantity q_{NG} or the smooth processed value q_{NGAVG} exceeds the predetermined time. Therefore, since the number of times that the actual continuation quantity q_{NG} or the smooth processed value q_{NGAVG} exceeds the predetermined time is stored in the storing means 110, it is possible to reduce the amount of information to be stored in the storing means 110, thereby preventing garbling of the storage value and/or deterioration of the durability of the storing means 110.

Also, according to the embodiment, the continuation quantity q_{NG} is the duration t_{NG} of the operation state in which the predetermined failure precondition is satisfied, and the storing means 110 (SA4) stores the actual continuation quantity q_{NG} or the smooth processed value q_{NGAVG} which exceeds the predetermined time. Therefore, since only the actual continuation quantity q_{NG} or the smooth processed value q_{NGAVG} which exceeds the predetermined time is stored in the storing means 110, it is possible to reduce the amount of information to be stored in the storing means 110, thereby preventing garbling of the storage value and/or deterioration of the durability of the storing means 110.

Also, according to the embodiment, the storing means 110 (SA4) stores the maximal value of the actual continuation quantity q_{NG} or the maximal value of the smooth processed value q_{NGAVG}. Therefore, since the storing means 110 stores only the maximal value of the actual continuation quantity q_{NG} or the maximal value of the smooth processed value q_{NGAVG}, it is possible to reduce the amount of information to be stored in the storing means 110, thereby preventing garbling of the storage value and/or deterioration of the durability of the storing means 110.

Also, according to the embodiment, the failure determination threshold value correcting means 114 (SA5) does not correct the failure determination threshold value H_{SH} when a failure determination for the control apparatus is not performed by the failure determining means 116 (SB4). Therefore, the failure determination threshold value H_{SH} is corrected by the failure determination threshold value correcting means 114 only when a failure determination is performed. As a result, it is possible to appropriately determine whether a failure has occurred.

Also, according to the embodiment, the storing means 110 (SA4) does not store the actual continuation quantity q_{NG} or the smooth processed value q_{NGAVG} when a failure determination for the control apparatus, e.g. the lock-up clutch 26 is not performed by the failure determining means 116 (SB4). Therefore, the actual continuation quantity q_{NG} or the smooth processed value q_{NGAVG} stored in the storing means 110 does not include the actual continuation quantity q_{NG} or the smooth processed value q_{NGAVG} when a failure determination is not performed. Therefore, it is possible to appropriately correct the failure determination threshold value using the failure determination threshold value correcting means 114 (SA5), and to appropriately determine whether a failure has occurred.

Also, according to the embodiment, since the control apparatus is the power transmission system which transmits power from the engine to the drive wheels, it is possible to appropriately determine whether a failure has occurred in the power transmission system. For example, it is appropriately determined whether a failure has occurred in the linear solenoid valve SLU which controls the hydraulic pressure of the lock-up clutch 26 provided in the torque converter 14 as the power transmission system.

While the embodiment of the invention has been described in detail with reference to accompanying drawings, the invention can be realized in other embodiments.

For example, in the above-mentioned embodiment, the power transmission system as the control apparatus may be the automatic transmission 16, a front/rear wheel power distribution device with a power distribution clutch, or the like which distributes the engine output that is transmitted via the automatic transmission 16 to the drive wheels. For example, in the case of the automatic transmission 16, it is appropriately determined whether there a failure has occurred in the solenoid valves Sol1 to Sol5, the linear solenoid valves SL1 and SL2, and the like.

Also, in the above-mentioned embodiment, the failure determination threshold value correcting operation and the failure determination operation are performed according to different flowcharts, as shown in FIG. 12 and FIG. 13. However, the failure determination threshold value correcting operation and the failure determination operation may be performed according to one flowchart. In this case, SA4 and SA5 in FIG. 12 are performed, for example, between SB3 and SB4 in the flowchart in FIG. 13.

Also, according to the above-mentioned embodiment, the torque converter 14 provided with the lock-up clutch 26 is used as the fluid transmission device. However, a fluid coupling, which does not have torque amplification action, may be used.

Also, in the above-mentioned embodiment, the automatic transmission 16 is a six forward speed transmission including three planetary gear drives 40, 42 and 44. However, any types of transmission may be employed as long as the hydraulic friction engaging devices such as clutches C or the brakes C are engaged for engine brake effect. The number of the planetary gear drives constituting the automatic transmission 16 may be different from three. Also, the transmission with five forward speeds, or four forward speeds may be employed. Also, the automatic transmission 16 may be constituted of a shift portion formed of the hydraulic friction engaging devices such as clutches and brakes, or the one-way clutch, for example, forward/rearward switching or two forward speed transmission, and the continuously variable transmission in which the gear ratio is continuously changed.

Also, in the above-mentioned embodiment, the clutches C or the brakes B, which are the engaging elements of the automatic transmission 16, are hydraulic friction engaging devices. However, electromagnetic engaging devices such as electromagnetic clutches and the magnetic particle clutches may be employed.

While the invention has been described in detail with reference to the preferred embodiments, it will be apparent to those skilled in the art that the invention is not limited to the above-mentioned embodiments, and that the invention may be realized in various other embodiments within the scope of the invention.

1-20. (canceled)

21. A failure diagnosing device for a vehicular control apparatus, comprising:
a failure determining portion that determines that a failure has occurred in the control apparatus when a continuation quantity of an operation state of the control apparatus, in which a predetermined failure precondition is satisfied, exceeds a predetermined failure determination threshold value; and
a failure determination threshold value correcting portion that corrects the failure determination threshold value based on an actual continuation quantity of the operation state;
wherein correction by the failure determination threshold value correcting portion is performed based on the continuation quantity of the operation state where the control apparatus is operating normally and the continuation quantity is smaller than the failure determination threshold value.

22. The failure diagnosing device according to claim 21, wherein a storing portion that stores the actual continuation quantity is further provided, and the failure determination threshold value correcting portion corrects the failure determination threshold value based on a storage value stored in the storing portion.

23. The failure diagnosing device according to claim 22, wherein a continuation quantity detecting portion that detects the actual continuation quantity of the operation state of the control apparatus each time when the predetermined failure precondition is satisfied, and a smoothing portion that smoothes fluctuation in the continuation quantity of the operation state which is repeatedly detected by the continuation quantity detecting portion are further provided, and the storing portion stores a smooth processed value obtained by the smoothing portion.

24. The failure diagnosing device according to claim 22, wherein the continuation quantity is a duration of the operation state in which the predetermined failure precondition is satisfied, and the storing portion stores the number of times that the actual continuation quantity or the smooth processed value exceeds the predetermined time.

25. The failure diagnosing device according to claim 22, wherein the continuation quantity is a duration of the operation state in which the predetermined failure precondition is satisfied, and the storing portion stores the actual continuation quantity or the smooth processed value which exceeds the predetermined time, when the actual continuation quantity or the smooth processed value exceeds the predetermined time.

26. The failure diagnosing device according to claim 22, wherein the storing portion stores a maximal value of the actual continuation quantity or a maximal value of the smooth processed value.

27. The failure diagnosing device according to claim 21, wherein the failure determination threshold value correcting portion does not correct the failure determination threshold value, when a failure determination for the control apparatus is not performed by the failure determining portion.

28. The failure diagnosing device according to claim 22, wherein the storing portion does not store the actual continuation quantity or the smooth processed value, when a failure determination for the control apparatus is not performed by the failure determining portion.

29. The failure diagnosing device according to claim 21, wherein the control apparatus is a power transmission system which transmits power of an engine to drive wheels.

30. A failure diagnosing method for a vehicular control apparatus, which includes a failure determining step for determining that a failure has occurred in the control apparatus when a continuation quantity of an operation state of the control apparatus, in which a predetermined failure precondition is satisfied, exceeds a predetermined failure determination threshold value, further comprising:
correcting the failure determination threshold value based on an actual continuation quantity of the operation state;
wherein the correction is performed based on the continuation quantity of the operation state where the control apparatus is operating normally and the continuation quantity is smaller than the failure determination threshold value.

31. The failure diagnosing method according to claim 30, wherein:
the actual continuation quantity is stored; and
the failure determination threshold value is corrected on the basis of a storage value of the actual continuation quantity.

32. The failure diagnosing device according to claim 31, wherein:
the actual continuation quantity of the operation state of the control apparatus is detected each time when the predetermined failure precondition is satisfied;
smoothing process for smoothing fluctuation in the continuation quantity of the operation state which is repeatedly detected is performed; and
a smooth processed value of the continuation quantity is stored.

33. The failure diagnosing method according to claim 31, wherein:
the continuation quantity is a duration of the operation state in which the predetermined failure precondition is satisfied; and
the number of times that the actual continuation quantity or the smooth processed value exceeds the predetermined time is stored.

34. The failure diagnosing method according to claim 31, wherein:
the continuation quantity is a duration of the operation state in which the predetermined failure precondition is satisfied; and
the actual continuation quantity or the smooth processed value which exceeds the predetermined time is stored, when the actual continuation quantity or the smooth processed value exceeds the predetermined time.

35. The failure diagnosing method according to claim 31, wherein a maximal value of the actual continuation quantity or a maximal value of the smooth processed value is stored.

36. The failure diagnosing method according to claim 30, wherein the failure determination threshold value is not corrected when a failure determination for the control apparatus is not performed.

37. The failure diagnosing device according to claim 31, wherein the actual continuation quantity or the smooth processed value is not stored when a failure determination for the control apparatus is not performed.
